(19) United States
(12) Patent Application Publication
(10) Pub. No.: US 2009/0185630 A1
(43) Pub. Date: Jul. 23, 2009

(54) METHOD AND APPARATUS FOR ESTIMATING THE CHANNEL IMPULSE RESPONSE OF MULTI-CARRIER COMMUNICATING SYSTEMS

(75) Inventor: Shun-An Yang, Changhua County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/018,242

(22) Filed: Jan. 23, 2008

(51) Int. Cl. H04L 27/28

(52) U.S. Cl. 375/260

(57) ABSTRACT

An apparatus for estimating channel impulse response. The apparatus comprises an IFFT module, a tap selection module, a correlation module, a correlation module, and a decision module. The IFFT module receives and transforms a plurality of pilot tones into a periodic discrete-time series. The tap selection module selects two taps from the periodic discrete-time series and obtains time differences of the two selected taps Dt and Dt′. The correlation module receives a time-directional symbol having time index k r(k) and a time-directional symbol having time index (k+Dt) r(k+Dt) to correlate a first correlated result C(Dt) and receives the time-directional symbol having time index k r(k) and a time-directional symbol having time index (k+Dt′) r(k+Dt′) to correlate a second correlated result C(Dt′). The decision module compares the first and second correlated result and outputs a channel impulse response according to the first and second correlated results.

### BACKGROUND OF THE INVENTION

### Field of the Invention

The invention relates to electromagnetic signals receivers employing multi-carrier modulation, and, more particularly, to channel estimation of multi-carrier modulation in a communication system.

In wireless communication systems, a signal may be sent at a certain frequency within a transmission path. Recent developments have enabled the simultaneous transmission of multiple signals over a single transmission path. One of these methods of simultaneous transmission is Frequency Division Multiplexing (FDM). In FDM, the transmission path is divided into sub-channels. Information (e.g. voice, video, audio, text, data, etc.) is modulated and transmitted over the sub-channels at different sub-carrier frequencies.

A particular type of FDM is Orthogonal Frequency Division Multiplexing (OFDM). In a typical OFDM transmission system, the number of sub-carriers is a power of 2. However, there may also be 2N+1 OFDM sub-carriers, including the zero frequency DC sub-carrier, not generally used to transmit data since it has no frequency. An OFDM system forms its symbol by taking m complex QAM symbols Xₘ, each modulating a sub-carrier with frequency fₘ=k/Tᵤ, where Tᵤ is the sub-carrier symbol period. Each OFDM sub-carrier displays a sinc x=(sin x)/x spectrum in the frequency domain. FIG. 1 shows a sinc spectrum. By spacing each of the 2N+1 sub-carriers 1/Tᵤ apart in the frequency domain, the primary peak of the sinc x spectrum of each sub-carrier coincides with a null of the spectrum of every other sub-carrier, as shown in FIG. 2. In this way, although the spectra of the sub-carriers overlap, they remain orthogonal to one another. An advantage of OFDM technology is that it is generally capable of overcoming multiple path effects. Another advantage of OFDM technology is that it can typically transmit and receive large amounts of information. Because of these advantages, much research has been devoted to advancing OFDM technology.

Channel estimation relies on pilot sub-carriers. Pilot tones are a sequence of frequencies in which the transmitted value is already known by the receiver, thus, an OFDM receiver can use the pilot values to perform channel estimation. Knowledge of channel impulse response can be used to improve the quality of window selection and channel estimation. However, in most communication systems, pilots are available only for a portion of the sub-carriers. Hence, the channel information gained from pilots is limited.

For some multi-carrier communication systems having scattered pilots, interpolating the scattered pilot information to one OFDM symbol often facilitates estimation the channel impulse response. Scattered pilot carriers are pilots distributed throughout an OFDM symbol, and their location typically changes from symbol to symbol. An IFFT module (Inverse-Fast-Fourier Transform) can be used to determine the channel impulse response according to the interpolated pilot information. Due to the periodic property of IFFT, an uncertainty about the position of the channel impulse response exists.

### BRIEF SUMMARY OF THE INVENTION

Methods and apparatuses for estimating the channel impulse response in OFDM communication systems are provided. The method resolves the ambiguity in the channel impulse response without affecting the reception of data, thus, the performance of an OFDM receiver is improved. In practice, the proposed method is suitable for DVB-T systems.

An embodiment of an apparatus for estimating channel impulse response features an FFT module, a pilot identifier, an IFFT module, a tap selection module, a correction module, and a decision module. The FFT module receives a time-directional symbol and transforms the time-directional symbol into an OFDM symbol, wherein the OFDM symbol comprises a plurality of data tones and a plurality of pilot tones. The pilot identifier extracts the plurality of pilot tones from the OFDM symbol. The IFFT module transforms the plurality of pilot tones identified by the pilot identifier into a periodic discrete-time series. The periodic discrete-time series comprises channel impulse response information, and the period of the periodic discrete-time series is L. The tap selection module selects two taps from the periodic discrete-time series, and obtains time differences between the two selected taps Dt and Dt′, wherein Dt′ equals L−Dt. The correlation module correlates a time-directional symbol having time index k r(k) with a time-directional symbol having time index (k+Dt) r(k+Dt) to obtain a first correlated result C(Dt), and correlates the time-directional symbol having time index k r(k) with a time-directional symbol having time index (k+Dt′) r(k+Dt′) to obtain a second correlated result C(Dt′). The decision module compares the first and second correlated result and outputs a channel impulse response according the first and second correlated result.

An embodiment of a method for estimating channel impulse response is also provided. The method comprises: receiving a time-directional symbol and transforming the time-directional symbol into an OFDM symbol, wherein the OFDM symbol comprise a plurality of data tones and a plurality of pilot tones; the plurality of pilot tones are thus extracted from the OFDM symbol; the plurality of pilot tones identified by the pilot identifier are inverse-Fourier-transformed into a periodic discrete-time series comprising channel impulse response information, and a period of the periodic discrete-time series is L; two taps from the periodic discrete-time series are selected, and two time differences of the two selected taps Dₜ and D_{t′} are calculated, wherein Dt′ equals L−Dt; a time-directional symbol having time index k r(k) is correlated with a time-directional symbol having time index (k+Dt) r(k+Dt) to obtain a first correlated result C(Dt); the time-directional symbol having time index k is further correlated with a time-directional symbol having time index (k+Dt′) r(k+Dt′) to obtain a second correlated result C(Dt′). The first correlated result is compared with the second correlated result; a channel impulse response is then determined according to the first and second correlated result.

Another embodiment of an apparatus for estimating channel impulse response comprises: an IFFT module; a tap selection module; a correlation module, and a decision module. The IFFT module receives a plurality of pilot tones and transforms the plurality of pilot tones into a periodic discrete-time series, wherein the periodic discrete-time series comprises channel impulse response information, and the period of the periodic discrete-time series is L. The tap selection module selects two taps from the periodic discrete-time series and obtains time differences between the two selected taps Dt and Dt′, wherein Dt′ equals L−Dt. The correlation module receives a time-directional symbol having time index k r(k) and a time-directional symbol having time index (k+Dt) r(k+Dt) to correlate a first correlated result C(Dt) and receives the time-directional symbol having time index k r(k) and a time-directional symbol having time index (k+Dt′) r(k+Dt′) to correlate a second correlated result C(Dt′). The decision module compares the first and second correlated results and outputs a channel impulse response according to the first and second correlated result.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the present invention.

FIG. 1 shows a sinc spectrum of an OFDM sub-carrier;

FIG. 2 shows a frequency spectrum for multiple carriers in a OFDM signal;

FIG. 3 shows a block diagram of an embodiment of channel estimation apparatus;

FIG. 4 shows an exemplary periodic discrete-time series;

FIG. 5A and FIG. 5B respectively shows two possible channel impulse responses hₐ[n] and h_{b}[n];

FIG. 6 is a block diagram illustrating an embodiment of a correlation module according to an embodiment of the invention;

FIGS. 7A and 7B respectively show the start and end points of the correlation according to different embodiments of the invention;

FIG. 8 shows an embodiment of a decision module;

FIG. 9A and FIG. 9B each show an exemplary tap selection;

FIG. 10 shows a correlation module comprising a path widening filter;

FIG. 11 shows the pattern of scattered pilots, carriers, and interpolated pilots;

FIG. 12 shows a block diagram of a DVB-T transmitter and receiver;

FIG. 13 shows the pattern of inserted pilots according to the DVB-T specification; and

FIG. 14 shows a flowchart of an embodiment of a channel estimation method.

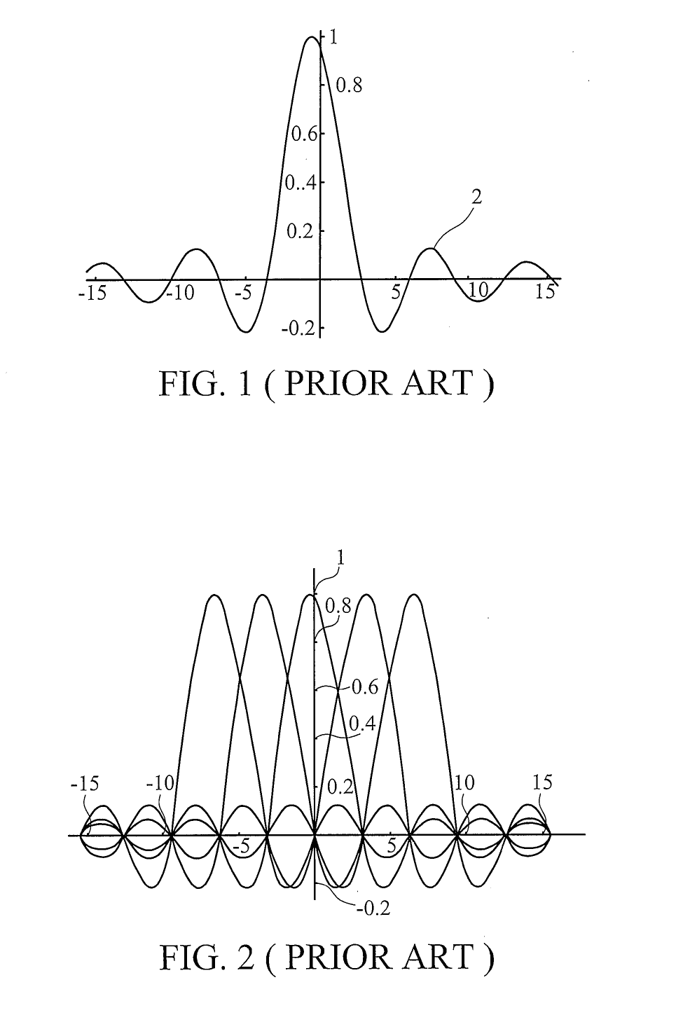

### DETAILED DESCRIPTION OF THE INVENTION

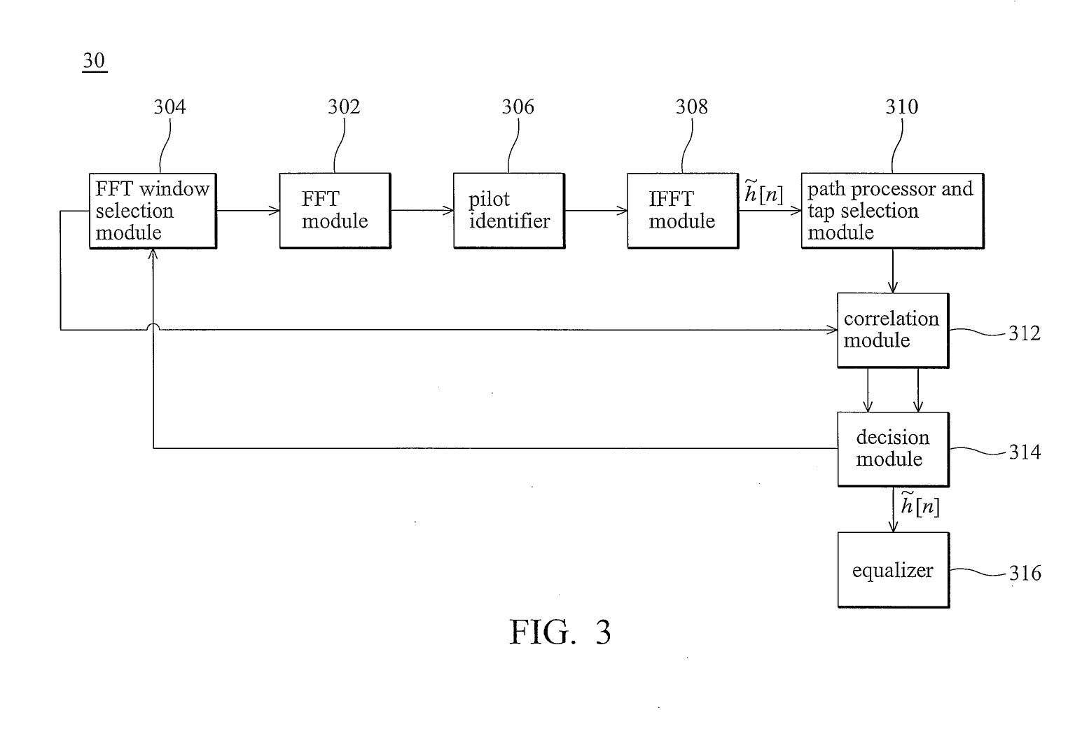

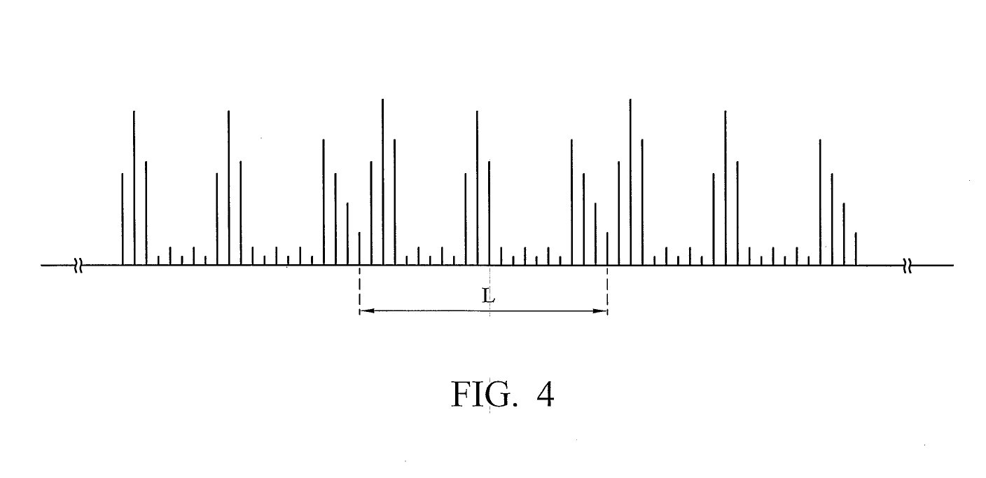

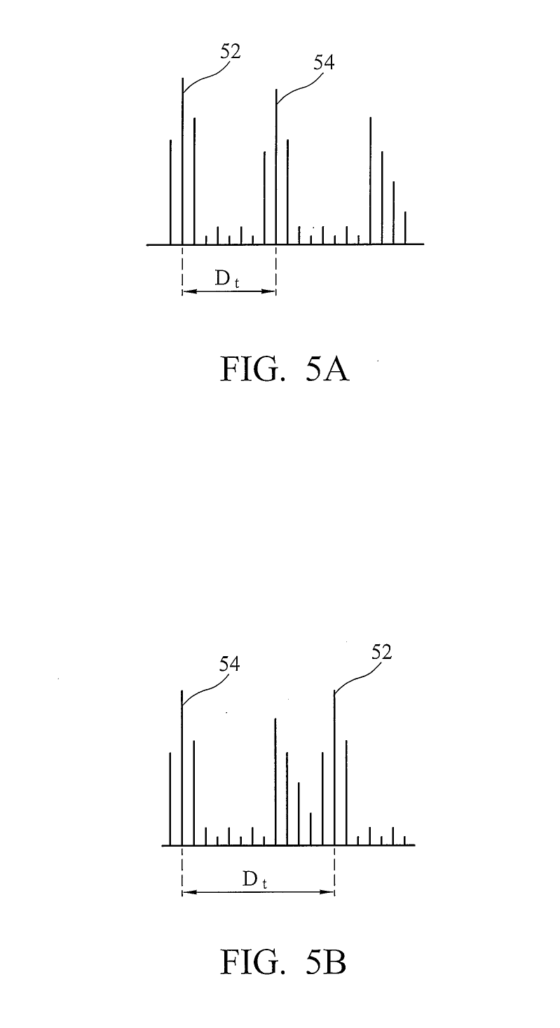

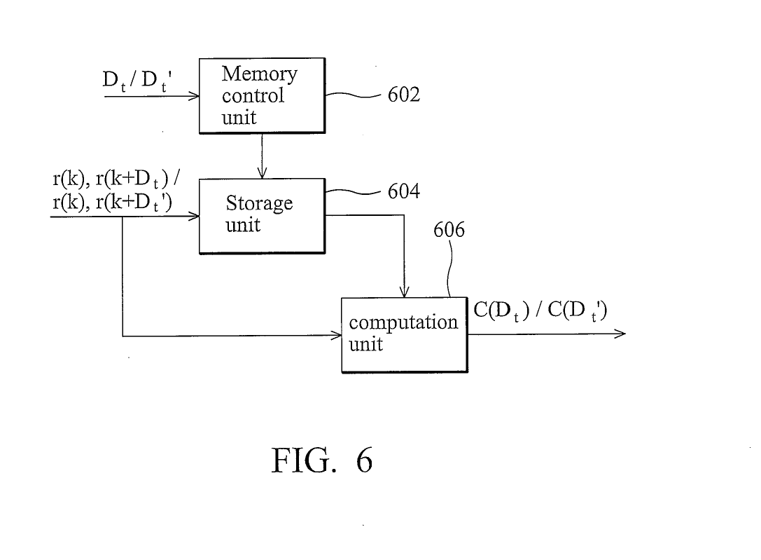

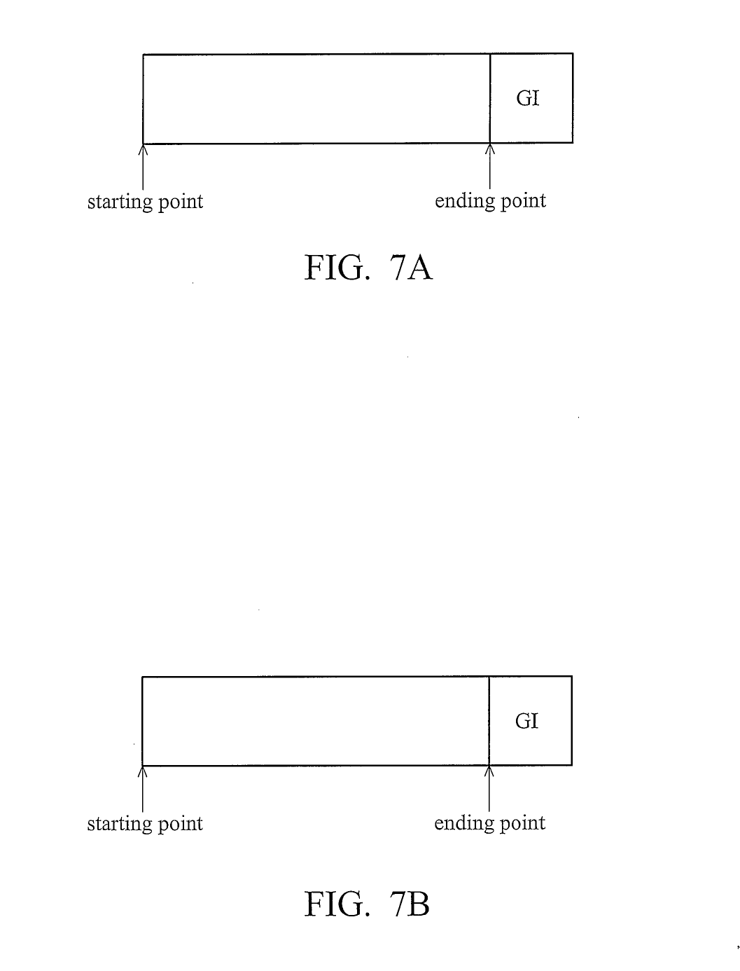

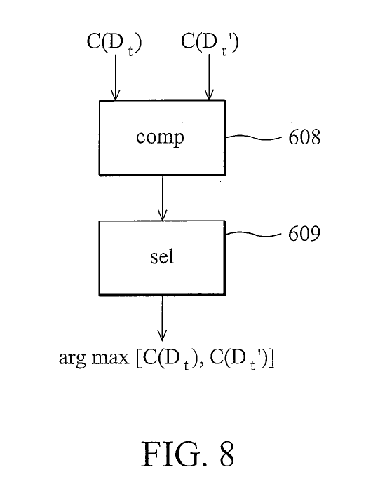

FIG. 3 shows a block diagram of an embodiment of a channel estimation apparatus 30. An FFT (Fast-Fourier-Transform) module 302 receives a time-directional symbol and transforms the time-directional symbol into an OFDM symbol (in the frequency domain), which may comprise a plurality of data tones (data sub-carriers) and pilot tones (pilot sub-carriers). The time-directional symbol boundary is determined by a FFT window selection module 304. The OFDM symbol is sent to a pilot identifier 306. The pilot identifier 306 extracts the pilots from the OFDM symbol and divides the received pilot values by the corresponding transmitted pilot values. The output of the pilot identifier module 306 is sent to an IFFT module 308 to obtain a periodic discrete-time series \tilde{h}[n]. FIG. 4 shows an exemplary periodic discrete-time series. The periodic discrete-time series \tilde{h}[n] comprises channel impulse response information h[n]. It is difficult, however, to distinguish or verify the true position of a channel impulse response from the periodic discrete-time series \tilde{h}[n]. Two possible channel impulses responses hₐ[n] and h_{b}[n] are shown in FIG. 5A and FIG. 5B. Note that the difference between these channel impulse responses lies in different tap permutation. Thus, the problem of confirming whether FIG. 5A or FIG. 5B is more likely to be the true channel impulse response h[n] can be modified to confirm which tap, such as tap 52 or tap 54, occurs first. The tap path processor and tap selection module 310 selects two taps from the periodic discrete-time series \tilde{h}[n]. To determine which tap occurs first the other one, the time difference between the two possible channel impulse responses is calculated. The time difference between selected taps at channel impulse response hₐ[n] is noted as Dₜ, and the time difference between selected taps at channel impulse response h_{b}[n] is noted as D_{t′}, where D_{t′} equals L−Dₜ. L is the period of the periodic discrete-time series \tilde{h}[n]. Preferably, the path processor and tap selection module 310 selects the largest tap from a cluster of taps; however, the invention is not limited thereto. A correlation module 312 first correlates an OFDM symbol having time index k r(k) with another OFDM symbol having time index k+Dₜ r(k+Dₜ) to obtain a first correlated result C(Dₜ). The correlation module 314 also correlates an OFDM symbol having time index k r(k) with another OFDM symbol having time index k+D_{t′} r(k+D_{t′}). FIG. 6 is a block diagram illustrating an embodiment of the correlation module 312. A memory control unit 602 receives time differences Dₜ and D_{t′}. The storage unit receives r(k) and r(k+D_{t′}), and the computation unit computes the product of r(k) times r*(k+D_{t′}). Because the correlation module 312 correlates through one time-direction symbol duration at a time, the product is reserved and the storage unit 604 receives r(k+1) and r(k+Dₜ+1). The computation unit 606 computes the product of r(k+1) times r*(k+Dₜ+1), and repeats until the end of the time-directional symbol. The FIG. 7A shows the starting and ending point of the correlating. In other embodiments, the start and end point can start at the beginning of one time-direction symbol and end at the guard interval of the symbol, as shown in FIG. 7B. More details of guard intervals will be described later. A decision module 314 in FIG. 8 compares the results of correlations C(Dₜ) and C(D_{t′}) using a comparator 608, and selects the time difference with a larger correlation using a selector 609. For example, if C(Dₜ) exceeds C(D_{t′}), the time difference between the two selected taps is then confirmed as Dₜ. In other words, it is verified by the apparatus 30 that tap 52 occurred before tap 54. The estimated channel impulse h[n] can be applied to an equalizer 316 shown in FIG. 3. Apart from being applied in equalization, the estimated channel impulse h[n] can further adjust the window size and position of FFT window selection module 304.

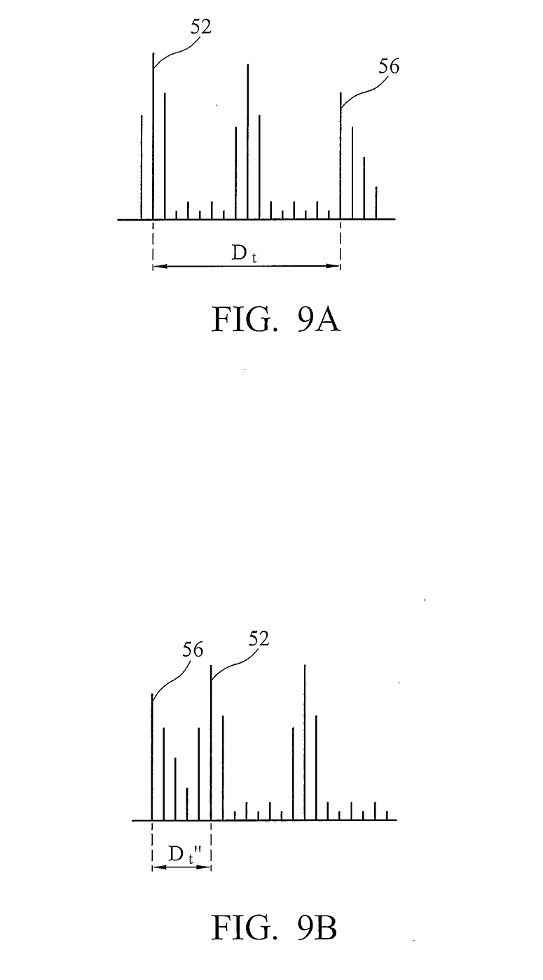

Continuously selecting other tap(s) from the periodic discrete-time series \tilde{h}[n] can eventually distinguish an exact channel impulse response. For example, selecting taps 56 and 52 shown in FIG. 9A and FIG. 9B which have time difference either D_{t″} or (L−D_{t″}), and calculating the correlations C(D_{t″}) and C(L−D_{t″}), and comparing C(D_{t″}) with C(L−D_{t″}) can verify whether tap 56 is prior than tap 52 or not.

Preferably, the IFFT module 308 has a power of 2 points. When the pilot tones are not precisely 2ⁿ, the IFFT module 308 may select the succeeding 2ⁿ pilot tones. However, the selection of IFFT points is not limited thereto in the invention. Arbitrary selection of IFFT points also works.

In some embodiments of the invention, the path processor and tap selection module 310 also includes function of path processing. The size (points) of the IFFT module may be up to several thousand, and because the number of taps from the IFFT module 308 is equal to the size of IFFT module 308, the number of taps of the IFFT module 308 may be so large that the estimated channel impulse response is ineffective. Moreover, a channel impulse response with too many taps would make calculating correlations inconvenient. The path processor is employed to shorten the length of tap numbers. The path processor may regularly decimate several taps, or regularly integrate several taps. Preferably, the path processor integrates every 12-16 taps to shorten the channel impulse response.

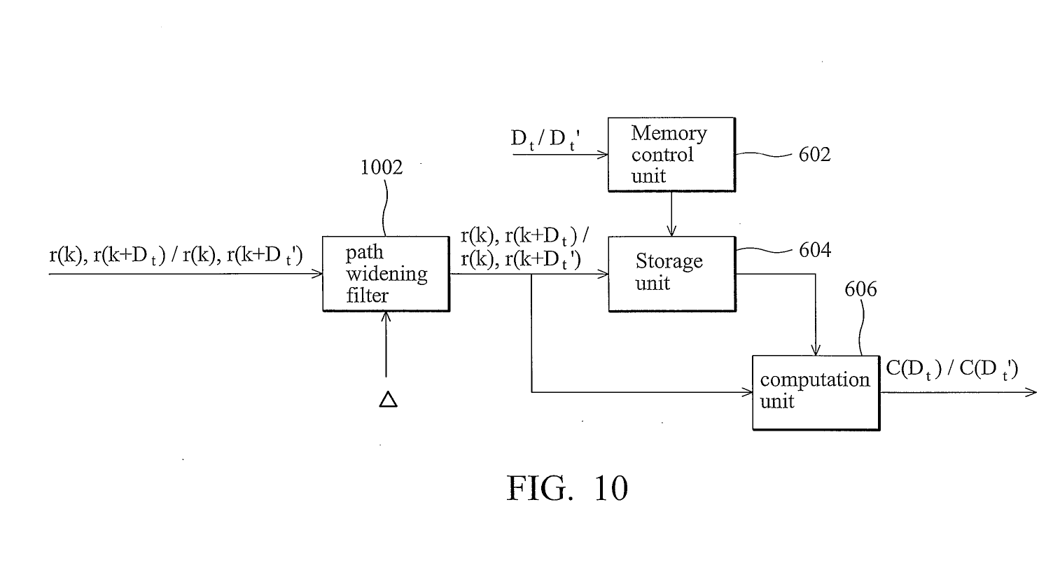

In some embodiments of the invention, the correlation module 312 further comprises a path widening filter, as shown in FIG. 10. The path widening filter 1002 filters the symbols with a finite-length filter before correlation. In one embodiment of the invention, the path widening filter 1002 is a low-pass filter. The time difference between Dt and Dt′ may drift to Dt+Δ under some circumstances. Thus, fine tuning of the path width may obtain more precise correlated results.

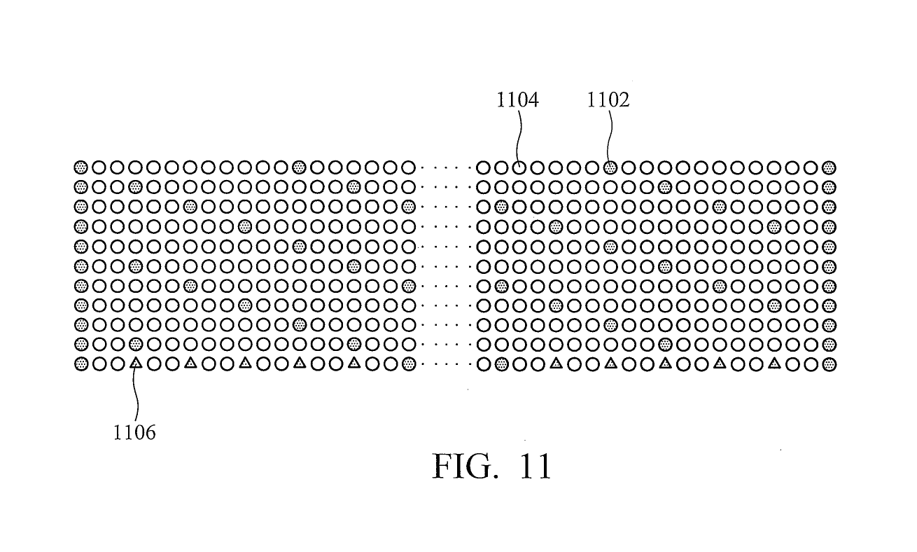

In a system with scattered pilots, the pilot identifier 306 further interpolates pilots from other OFDM symbols to obtain a longer duration channel impose response. The pilot interpolation module 306 may inner-interpolate from previous symbols or outer-interpolate the pilot from previous and following symbols. FIG. 11 shows the pattern of scattered pilot, carriers, and interpolated pilots.

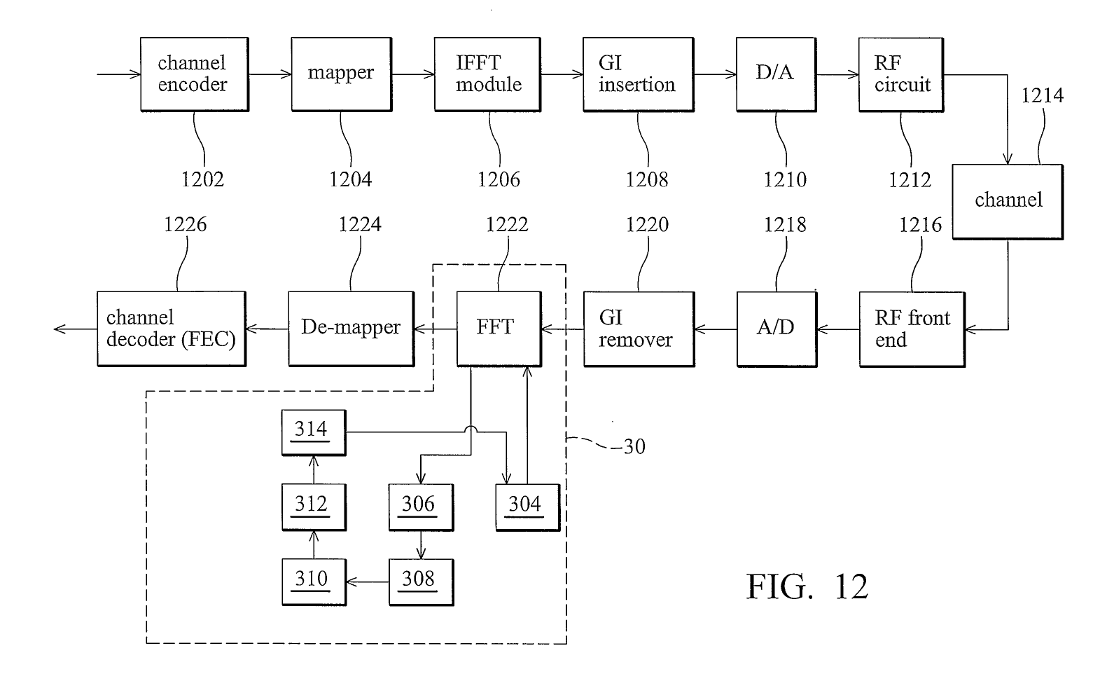

Preferably, the apparatus can be employed is a digital video broadcasting-terrestrial (DVB-T) receiver. FIG. 12 shows a block diagram of a DVB-T transmitter and receiver. An MPEG-2 data stream is encoded by a channel encoder 1202 to provide sufficiently robust protection against channel interference. The channel encoder 1202 comprises a Reed-Solomon (RS) encoder, outer interleaver, convolutional encoder, and an inner interleaver. After channel encoding and interleaving in block 1202, the data is mapped into a signal constellation. The mapped data along with pilot tones are organized into an OFDM symbol. The pilots are typically of two types. Continual pilot tones are transmitted in the same location in each OFDM symbol, with the same phase and amplitude. Scattered pilot carriers are distributed throughout the OFDM symbol, and their location typically changes from symbol to symbol. In 2 k mode, each OFDM symbol comprises 1705 tones spaced approximately 4.464 kHz apart; in 8 k mode, OFDM symbols comprise 6817 tones at nominally 1.116-kHz intervals. Reserved carriers convey synchronization and transmission-parameter-signaling information inserted at intervals throughout the ensemble. For the OFDM symbol of index k (ranging from 0 to 67), tones for which index m belongs to the subset

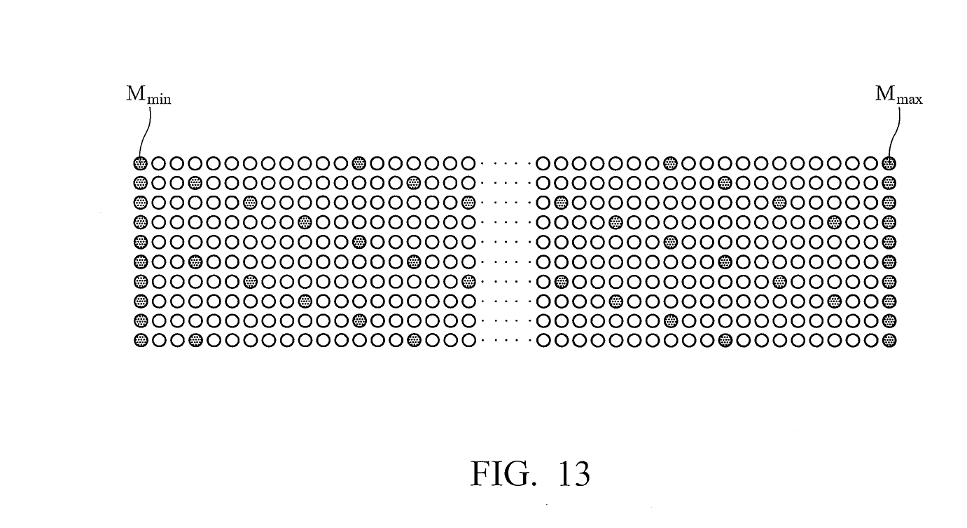

{m=Mₘᵢₙ+3×(k mod 4)+12p|p integer, p≧0. mε[Mₘᵢₙ; Mₘₐₓ]}, (1)

Where Mₘᵢₙ is 0 and Mₘₐₓ is 1704 in 2K mode, and Mₘₐₓ is 6816 in 8K mode. FIG. 13 shows the pattern of inserted pilots in the DVB-T specification. Next, the data tones and pilot tones are modulated at the baseband by the inverse fast Fourier transform (IFFT) in block 1206. A guard interval is then inserted at block 1208. A guard interval precedes the useful content of each symbol to prevent symbol collision, particularly in multi-path environments. The guard interval is selectable between ¼ and 1/32 of the basic 896-(8 k) or 224-μsec (2 k) useful symbol length. Together with modulation method and code rate, the guard interval helps determine the overall bit-rate capacity, ranging from about 5 to 32 Mbps. The discrete symbols are then converted to analog by block 1210, typically low-pass filtered, and then up-converted to radio frequency in block 1212. The signal is then transmitted through a channel 1214 and received by a receiving end.

Basically, the receiver applies an inverse of the transmission process to obtain the transmitted information. An RF front end 1216 down-converts the radio frequency to an intermediate frequency. An analog-to-digital converter (A/D) 1218 samples the intermediate frequency signal, and converts the continuous signal into discrete-time. A guard interval remover 1220 removes the guard interval added in block 1208. An FFT module 1222 transforms the time-direction symbol into an OFDM symbol. The OFDM symbol is de-mapped by a de-mapper 1224 and passes through FEC stage 1226 comprising outer-deinterleaver, Viterbi decoder, inner-deinterleaver, and Reed-Solomon code-correction. The output of the FEC stage is the MPEG-2 transport stream that can be decompressed and decoded by a video processor. For precise de-mapping of OFDM symbols, a correctly estimated channel impulse response is required. A channel impulse response estimator 1228 the same as that shown in FIG. 3 coupled to the FFT module 1222 and de-mapper module 1224 can provide the demanded channel impulse response. Note that this apparatus is explained with reference to the above noted DVB-T standard, but is applicable to many forms of frequency division multiplexing having prefixed or postfixed guard intervals.

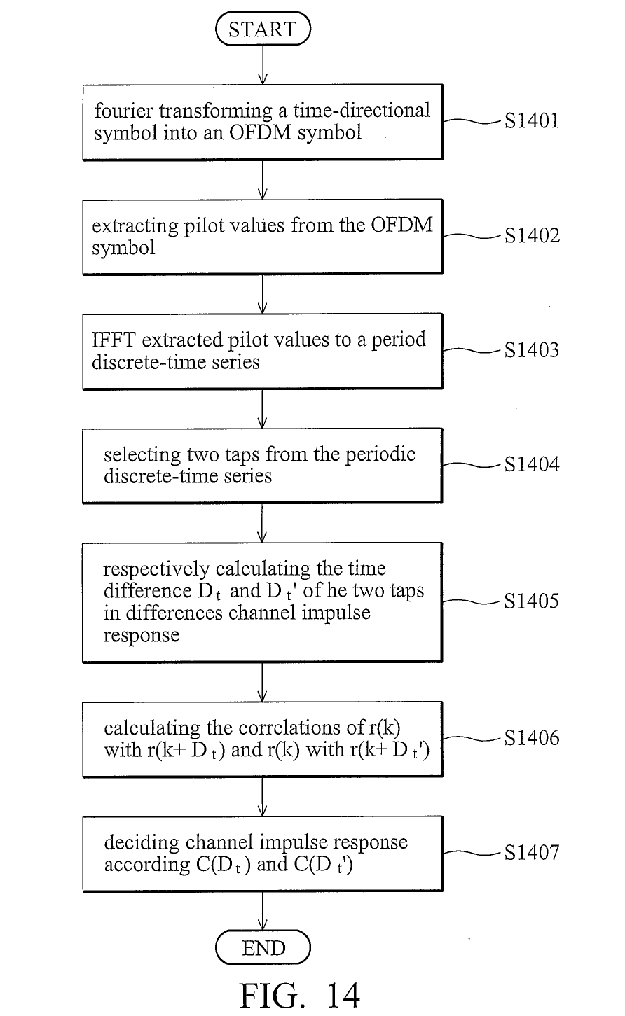

A method of estimating channel impulse response is provided. FIG. 14 shows a flowchart of a channel estimation method according to an embodiment of the invention. First, a time-directional symbol is received and transformed into an OFDM symbol in step S1401. The symbol boundary is determined by an FFT window selection module. Pilot values are extracted from the OFDM symbol and divided by the corresponding transmitted pilot values in step S1402. The extracted pilot values in step S1403 are inverse-Fourier-transformed to a periodic discrete-time series \tilde{h}[n]. The periodic discrete-time series can be similar that of FIG. 4. The periodic discrete-time series \tilde{h}[n] comprises channel impulse response information. One period of the discrete-time series \tilde{h}[n] is the true channel impulse response; however, it may be different to exactly determine the head and tail from the periodic series. Two possible channel impulses responses are the same as shown in FIG. 5A and FIG. 5B. Two taps from the periodic discrete-time series are selected in step S1404. The problem of confirming whether FIG. 5A or FIG. 5B is more likely to be the true channel impulse response can be modified to confirm which selected tap, tap 52 or tap 54, comes first. The time differences of the selected taps at possible channel impulse responses are respectively calculated in step S1405. The time difference between selected taps in FIG. 5A is noted as Dₜ, and the time difference between selected taps in FIG. 5B is noted as D_{t′}. An OFDM symbol having time index k r(k) is correlated with another OFDM symbol having time index k+Dₜ r(r+Dₜ) in step S1406. The OFDM symbol having time index k r(k) is also correlated with another OFDM symbol having time index k+D_{t′} r(k+D_{t′}). The correlations may begin from the starting point of the time-directional symbol and end point at the end thereof, or from the starting point of the guard interval of the time-direction symbol to the end point thereof. The results of correlation C(Dₜ, Tₛ, Tₑ) can be represented as

$$C ( {D}_{t} , {T}_{s} , {T}_{e} ) = {\sum }_{k = {T}_{s}}^{{T}_{e}} r ( k ) \cdot r * ( k + {D}_{t} ) , \qquad ( 2 )$$

where Ts, Te is the starting point and ending point of the time-directional symbol, and the results of correlation C(D_{t′}, T_{s′}, T_{e′}) is

$$C ( {D}_{{t}^{′}} , {T}_{{s}^{′}} , {T}_{{e}^{′}} ) = {\sum }_{k = {T}_{{s}^{′}}}^{{T}_{e}^{′}} r ( k ) \cdot r * ( k + {D}_{{t}^{′}} ) . \qquad ( 3 )$$

The results of correlations C(Dₜ) and C(D_{t′}) are compared in step S1407. The time difference with the larger correlation is selected. For example, C(Dₜ) exceeds C(D_{t′}), then the time difference between the two selected taps is Dₜ. In other words, it is confirmed that tap 52 occurred before tap 54. The estimated channel impulse can be applied to an equalized 316 shown in FIG. 3.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for estimating channel impulse response, comprising:
a FFT module receiving a time-directional symbol and transforming the time-directional symbol into an OFDM symbol, wherein the OFDM symbol comprises a plurality of data tones and a plurality of pilot tones;
a pilot identifier extracting the plurality of pilot tones from the OFDM symbol;
an IFFT module transforming the plurality of pilot tones identified by the pilot identifier into a periodic discrete-time series, wherein the periodic discrete-time series comprises channel impulse response information, and the period of the periodic discrete-time series is L;
a tap selection module selecting two taps from the periodic discrete-time series, and obtaining time differences of the two selected taps Dₜ and D_{t′}, wherein D_{t′} equals L−Dₜ;
a correlation module correlating a time-directional symbol having time index k r(k) with a time-directional symbol having time index (k+Dₜ) r(k+Dₜ) to obtain a first correlated result C(Dₜ) and correlating the time-directional symbol having time index k r(k) with a time-directional symbol having time index (k+D_{t′}) r(k+D_{t′}) to obtain a second correlated result C(D_{t′});
a decision module comparing the first and second correlated results and outputting a channel impulse response according to the first and second correlated results.

2. The apparatus as claimed in claim 1 further comprising a FFT window selection module to determine the time-directional symbol boundary.

3. The apparatus as claimed in claim 2, wherein the channel impulse is applied to adjust a window size and position of the FFT window selection module.

4. The apparatus as claimed in claim 1, wherein the pilot identifier further divides the values of the pilot tones by corresponding transmitted pilot values.

5. The apparatus as claimed in claim 1, wherein the correlation module comprises:
a memory control unit receiving the time difference Dₜ or D_{t′};
a storage unit receiving the time-directional symbol r(k), the time-directional symbol r(k+Dₜ), and the time-directional symbol r(k+D_{t′}); and
a computation unit calculating the first correlated result C(Dₜ) according to the time-directional symbol r(k), the time-directional symbol r(k+Dₜ) and the second correlated result C(D_{t′}) according to the time-directional symbol r(k), the time-directional symbol r(k+D_{t′}).

6. The apparatus as claimed in claim 5, wherein the computation unit calculates the first correlated result from the start point of the time-directional symbol to the end point of the time-directional symbol.

7. The apparatus as claimed in claim 6, wherein the time-direction symbol further comprises a guard interval, and the computation unit calculates the first correlated result from starting point of the time-directional symbol to the end point of the time-directional symbol.

8. The apparatus as claimed in claim 5, wherein the correlation module further comprises a path widening filter filtering the time-directional symbol with a finite-length filter.

9. The apparatus as claimed in claim 8, wherein the path widening filter is a low-pass filter.

10. The apparatus as claimed in claim 1, wherein the decision module compares the first and second results of correlations C(Dₜ) and C(D_{t′}), and selects the time difference with a larger correlation to obtain the channel impulse response.

11. The apparatus as claimed in claim 1 further comprises an equalizer, and the channel impulse response is used to adjust the equalizer.

12. The apparatus as claimed in claim 1, wherein the IFFT module is a 2ⁿ points IFFT module, and when the number of pilot tones exceeds 2ⁿ, the IFFT selects succeeding 2ⁿ points as the input of the IFFT module.

13. The apparatus as claimed in claim 1 further comprising a path processor coupled to the IFFT module and the correlation module, wherein the path processor reduces the number of taps.

14. The apparatus as claimed in claim 13, wherein the path processor regularly eliminates a plurality of taps to reduce the tap numbers.

15. The apparatus as claimed in claim 13, wherein the path processor regularly integrates a plurality of taps to reduce the number of taps.

16. The apparatus as claimed in claim 13, wherein the path processor integrates every 12-16 taps to shorten the channel impulse response to reduce the tap numbers.

17. The apparatus as claimed in claim 1, wherein the pilot identifier further interpolates pilot tones from other OFDM symbols, and the IFFT module transforms the plurality of extracted pilot tones and the interpolated pilot tones into the periodic discrete-time series.

18. A method for estimating channel impulse response, comprising:
receiving a time-directional symbol and transforming the time-directional symbol into an OFDM symbol, wherein the OFDM symbol comprises a plurality of data tones and a plurality of pilot tones;
extracting the plurality of pilot tones from the OFDM symbol;
inverse-Fourier-transforming the plurality of pilot tones identified by the pilot identifier into a periodic discrete-time series, wherein the periodic discrete-time series comprises information about a channel impulse response, and a period of the periodic discrete-time series is L;
selecting two taps from the periodic discrete-time series, and obtaining the time difference of the two selected taps Dₜ and D_{t′}, wherein D_{t′} equals L−Dₜ;
correlating a time-directional symbol having time index k r(k) with a time-directional symbol having time index (k+Dₜ) r(k+Dₜ) to obtain a first correlated result C(Dₜ) and correlating the time-directional symbol having time index k with an time-directional symbol having time index (k+D_{t′}) r(k+D_{t′}) to obtain a second correlated result C(D_{t′});
comparing the first and second correlated results and outputting a channel impulse response according to the first and second correlated results.

19. The method as claimed in claim 18 further comprising dividing the values of the pilot tones by corresponding transmitted pilot values.

20. The method as claimed in claim 18, wherein the first and second correlated results are correlated from a start point of the time-directional symbol to an end point of the time-directional symbol.

21. The method as claimed in claim 18, wherein the first and second correlated result is correlated from a starting point of the time-directional symbol to the end point of a guard interval of the time-directional symbol, and the guard interval proceeds to the end of the time-directional symbol.

22. The method as claimed in claim 18, wherein the first and second correlated result is correlated from a start point of a guard interval of the time-directional symbol to the end point of the time-directional symbol, and the guard interval is proceeds to the start point of the time-directional symbol.

23. The method as claimed in claim 18 further comprising filtering the time-directional symbols r(k), r(k+Dₜ), and r(k+D_{t′}) with a finite-length filter before obtaining the first and second correlations.

24. The method as claimed in claim 18, wherein the first and second results of correlations C(Dₜ) and C(D_{t′}) are compared, and the time difference which has a larger correlation is selected to obtain the channel impulse response.
